(19) United States
(12) Patent Application Publication
(10) Pub. No.: US 2007/0201058 A1
(43) Pub. Date: Aug. 30, 2007

(54) Systems and methods for indirect image data conversion

(75) Inventors: Narendran Melethil Rajan, Kerala - 680623 (IN); Raghuram Karthik Jayaraman, TamilNadu - 641002 (IN); Prabhavathy Shakuntala, Bangalore -75 (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/365,144

(22) Filed: Feb. 28, 2006

(51) Int. Cl. G06F 15/00

(52) U.S. Cl. 358/1.9

(57) ABSTRACT

Various systems and methods involving image data conversion are discussed herein. As one example, a method for image data conversion is disclosed. The method includes receiving an image in a particular color space, and converting the received image from the particular color space to a reduced color space. Then, a conversion is performed to convert the image from the reduced color space to the full color space.

### BACKGROUND OF THE INVENTION

The present invention is related to systems and methods for data conversion, and in particular to systems and methods for conversion of image data from one format to another.

Both still and image data are often captured in one particular image format, and then subsequently used in another image format. This requires conversion between two or more image formats. This conversion process is often computationally intensive.

As one particular example, still image data and video image data is often converted from a YUV color space to an RGB color space. Such a conversion may be done, for example, in relation to a preview function for a digital still cameras, or in relation to image post-processing before final display in video conferencing applications. Conventionally, such a conversion utilizes the following equations:
R=aR*Y+bR*U+cR*V+dR;
G=aG*Y+bG*U+cG*V+dG;
B=aB*Y+bB*U+cB*V+dB;
where a, b, c and d are coefficients for multiplication. Considering the preceding equations, a conventional conversion from a YUV color space to an RGB color space requires three additions and three multiplications per pixel component. This is a total of nine additions and nine multiplications per pixel. As a still image may comprise millions or more pixels, it is easy to appreciate that the required computation can become intensive. Further, as video may be comprised of millions or more frames each composed of a large number of pixels, the computationally intensive nature of any color space conversion becomes readily apparent. The computationally intensive nature of such conversions become particularly problematic when a color space conversion is just one of many processes within a multi-media system that is competing for computational bandwidth.

Hence, for at least the aforementioned reasons, there exists a need in the art for advanced systems and methods for data conversion, and in particular for advanced systems and methods for performing a conversion from a YUV color space to an RGB color space.

### BRIEF SUMMARY OF THE INVENTION

The present invention is related to systems and methods for data conversion, and in particular to systems and methods for conversion of image data from one format to another.

Some embodiments of the present invention provide methods for image data conversion. The methods include receiving an image that is represented in a particular color space. The received image is converted to a reduced version of another color space, and the image represented in the reduced color space is then converted to the full color space or some superset of the reduced color space. The color spaces may be, but are not limited to, some combination of YUV, RGB, and XYZ color spaces.

In some particular instances of the embodiments, the color space in which the image is received is a YUV color space, and the color space to which the received image is to be converted is an RGB color space. Thus, the reduced color space is a reduced RGB color space. The reduced RGB color space is an RGB color space with less than a full complement of red, green and blue values for each spatial location. In some instances of the aforementioned embodiments, converting the image represented in the reduced color space to an image represented in the color space includes performing a de-mosaicing scheme. The de-mosaicing scheme may be, but is not limited to, a neighbor copy interpolation technique; a two-pixel neighbor copy hybrid interpolation technique; a hybrid triangulation technique; or a modified bi-linear interpolation.

In one particular case, the aforementioned reduced RGB color space includes a first row of spatial locations where each of the spatial locations are represented in alternating fashion by a single blue or green value, and wherein the reduced RGB color space includes a second row of spatial locations where each of the special locations are represented in alternating fashion by a single red or green value. In such a case, converting the received image to the image in the reduced RGB color space may include performing a conversion of only a single component for each spatial location of the image.

In another particular case, the reduced RGB color space includes a first row of spatial locations where each of the spatial locations are represented in alternating fashion by either a blue and a green value, or a red and a green value; and wherein the reduced RGB color space includes a second row of spatial locations where each of the special locations are represented in an opposite alternating fashion than that of the first row by either a red and a green value, or a blue and a green value. In such a case, converting the received image to the image in the reduced RGB color space may include performing a conversion for two components associated with each spatial location of the image.

Other embodiments of the present invention provide systems for image acquisition and/or image display. The systems for image acquisition may include a light sensitive device that is operable to receive light representing a scene. Such a light sensitive device may further be operable to communicate an image representing the scene in some color space such as, for example, a YUV color space. Such systems may further include a conversion device that is operable to receive the image of the scene; convert the image of the scene to a reduced color space, and convert the image of the scene represented in the reduced color space to an image of the scene in the full color space. Such systems may include a processor and a computer readable medium accessible by the processor. The computer readable medium includes software executable by the processor to perform one or more of the aforementioned operations of the conversion device. In addition to the conversion device, the systems for image display may include a display capable of displaying an image provided in a particular format such as, for example, RGB color format.

Yet other embodiments of the present invention provide systems for image data conversion. Such systems include a computer readable medium that has instructions executable by a processor to: receive a first image in a particular color space; convert the first image in the particular color space to a second image in a reduced RGB color space; and convert the second image in the reduced RGB color space to a third image in the RGB color space.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a flow diagram illustrating a method for image data conversion in accordance with various embodiments of the present invention;

FIG. 2 is a flow diagram depicting a method for image data conversion from a YUV color space to an RGB color space in accordance with particular embodiments of the present invention;

FIG. 3 show two exemplary reduced color spaces that may be used in accordance with some embodiments of the present invention;

FIG. 4 illustrates neighbor copying interpolation that may be used in relation to one or more embodiments of the present invention;

FIG. 5 depicts two-pixel neighbor copy interpolation that may be used in relation to one or more embodiments of the present invention;

FIG. 6 illustrates modified bi-linear interpolation that may be used in relation to one or more embodiments of the present invention; and

FIG. 7 is an image capture and display system in accordance with various embodiments of the present invention.

### DETAILED DESCRIPTION OF THE INVENTION

The present invention is related to systems and methods for data conversion, and in particular to systems and methods for conversion of image data from one format to another.

Some embodiments of the present invention provide methods for image data conversion. The methods include receiving an image that is represented in a particular color space. The received image is converted to a reduced version of another color space, and the image represented in the reduced color space is then converted to the full color space or some superset of the reduced color space. As used herein, the phrase “color space” is used in its broadest sense to mean any color format in which an image may be represented. Thus, as just some examples, a color space may be a YUV color space, an RGB color space, a CIELAB color space, a CMY or CMYK color space, an XYZ color space, or the like. Further, a source color space generally refers to a color space to which a conversion is to be applied, and a destination color space generally refers to a color space that is the result of a conversion from a source color space. Further, as used herein, the phrase “reduced color space” is used in its broadest sense to mean any representation of a color space where less than all of the components included in the color space are utilized. Thus, as just some of many examples, a reduced RGB color space may include only a combination of red values and not include the green and blue values from a standard RGB color space.

Also, as used herein, the phrase “superset of the reduced color space” is used in its broadest sense to mean any color space that includes all of the elements of the reduced color space plus some additional elements that would be expected in the full color space. Thus, a superset of the reduced color space may be something more than the reduced color space, up to the full color space. As an illustrative example, where the full color space is a full RGB color space with a red, green and a blue value for each spatial location and the reduced color space includes only a red value for each spatial location, a superset of the color space may include: a red and a green value for each spatial location; a red and a blue value for each spatial location; or a red, a green and a blue value for each spatial location. In general, where a conversion from a reduced color space to the color space is discussed herein, it implies a conversion from the reduced color space to a superset of the reduced color space. Only where the conversion explicitly states that the conversion is from the reduced color space to the full color space is such required. Based on the disclosure provided herein, one of ordinary skill in the art will recognize a variety of source color spaces, destination color spaces, and/or reduced color spaces that may be used in relation to one or more embodiments of the present invention.

Turning to FIG. 1, a flow diagram 100 illustrates a method for image data conversion in accordance with various embodiments of the present invention. Following flow diagram 100, an image is received in a particular source color space (block 105). Such an image may be received as a series of values representing spatial locations within the image. Thus, as one example, where the source color space is an RGB color space, a series of red, green and blue values are received for each pixel or spatial location within the image. The received image may be stored in a computer readable medium as a two dimensional array of pixel data, as a single stream of pixel data, or as some other representation.

The received image is converted from the source color space to a reduced color space (block 110). Thus, for example, where the color space to which the image is to be converted is an RGB color space, the image may be converted to a reduced RGB color space. Such a reduced RGB color space may be comprised of only the G and alternating B and R components of the RGB color space. By converting only to the reduced color space rather than the full color space, a substantial amount of computational bandwidth can be saved.

The image represented in the reduced color space is then converted to the full color space (block 115). Thus in the aforementioned example, the image represented by less than the full color space is converted such that the missing components are formed into the image representation. This can be done using a number of different techniques which often do not require substantial computational bandwidth.

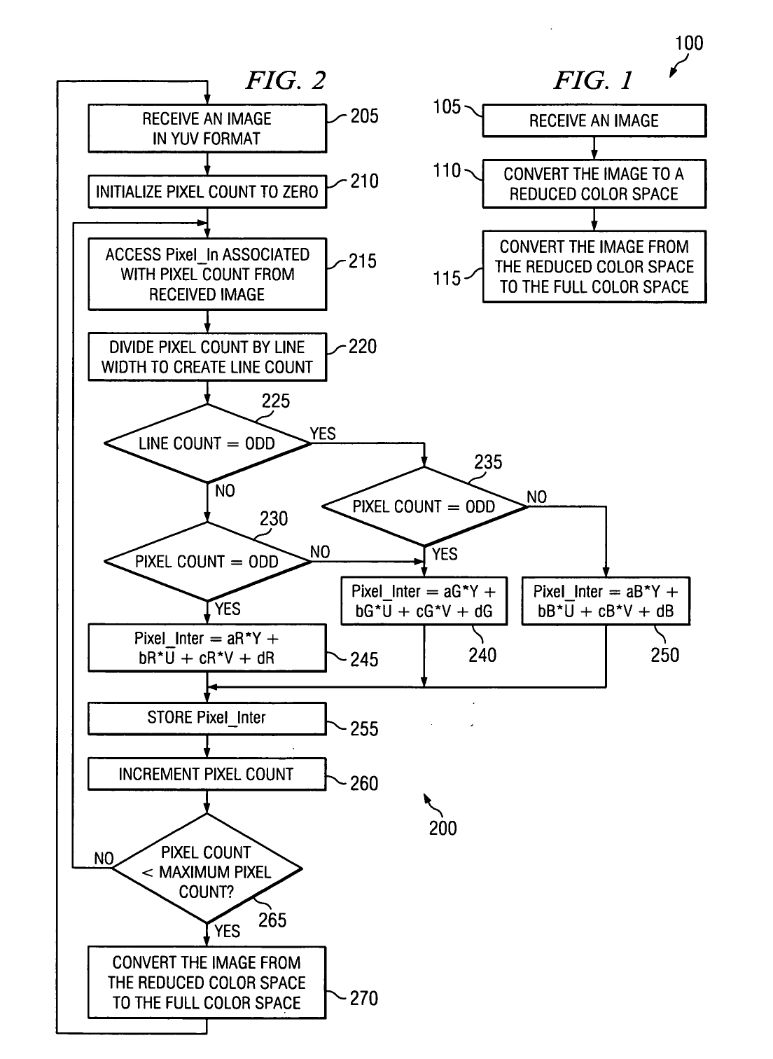

Some embodiments of the present invention utilize the human eye's sensitivity to green light compared to red and blue light to reduce the computational complexity of a conversion from the YUV color space to the RGB color space. In such embodiments, a computationally intense direct computation of RGB data from corresponding YUV data is supplanted by a computationally less intensive indirect conversions from the YUV color space to the RGB color space. This indirect computation includes a conversion from the YUV color space to a reduced RGB color space. FIG. 2 depicts one such method in accordance with embodiments of the present invention that rely upon this green sensitivity.

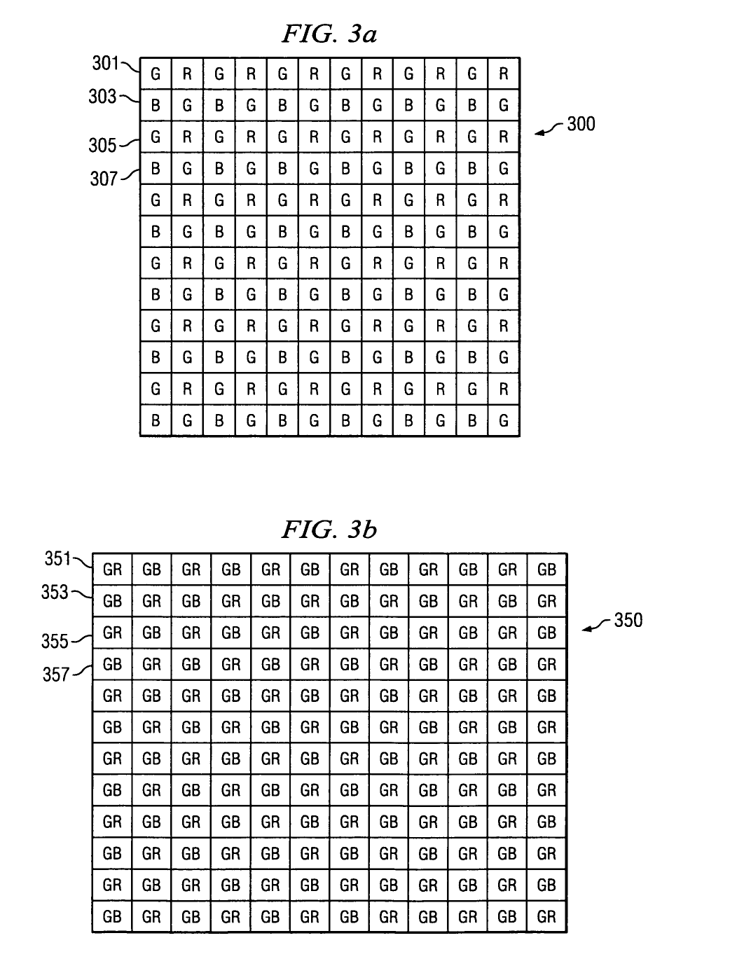

Turning now to FIG. 2, is a flow diagram 200 depicting a method for image data conversion from a YUV source color space to an RGB destination color space in accordance with particular embodiments of the present invention. In this case, the reduced color space is a reduced RGB color space. Turning to FIGS. 3, two exemplary reduced color spaces are shown. In particular, a reduced RGB color space 300 of FIG. 3a is that used by the method of FIG. 2. A reduced RGB color space 350 of FIG. 3b may also be used where the method of FIG. 2 is expanded to account for the additional RGB components.

Turning to FIG. 3a, reduced RGB color space 300 consists of a number of rows exemplified by rows 301, 305 of red and green pixel components; and rows 303, 307 of blue and green pixel components. Such an arrangement is often referred to as a Bayer Pattern, and was developed to exploit the increased sensitivity of the human visual system to luminance which is composed primarily of green light. Because of this sensitivity, the green components are included in an image array at twice the frequency of the red and blue components. Bayer Patterns are often used as color filter arrays (CFAS) in both digital still cameras and digital video cameras where cost prevents the provision of three sensors (i.e., one per pixel component) to each pixel location on an image array. Further background discussion of such Bayer Patterns is provided in U.S. Pat. No. 3,971,065, the entirety of which is incorporated herein by reference for all purposes.

As will be appreciated from considering FIG. 3a, reduced RGB color space 300 is an RGB structure with the red and blue components appearing at half the frequency of the green components, and where only one color component is available at each spatial or pixel location. It should be noted that other reduced RGB color spaces may be used in accordance with the various embodiments of the present invention. For example, a color space with twice as many green elements as red and blue elements combined may be utilized.

Following flow diagram 200 of FIG. 2, an image is received that is represented in the YUV color space (block 205), and a pixel count is initialized to zero (block 210). A pixel, Pixel_In, is accessed from the received image (block 215). The retrieved is indicated by the pixel count. Thus, for example, where the pixel count is equal to zero, the first pixel in the image is retrieved. Alternatively, where the pixel count is equal to one, the next pixel is retrieved. The pixel count is then divided by the number of pixels in a row or line of the image (block 220). This yields the row or line number to which the retrieved pixel belongs. As an example, assume the image is comprised of ten thousand pixels arranged as one hundred rows each with one hundred pixels, a pixel count of one hundred ten which is divided by the number of pixels per row (i.e., one hundred) would indicate that the pixel is on line one. Alternatively, a pixel count of twenty would indicate a pixel on line zero.

It is determined whether the line count is even or odd (block 225). Where the line count is odd (block 225), a line of blue and green elements as shown in FIG. 3a as rows 303, 307 is to be created. Alternatively, where the line count is not odd (block 225), a line of red and green elements as shown in FIG. 3a as rows 301, 305 is to be created. What is left to be determined is whether the pixel count is odd or even (blocks 230, 235). Thus, for a line count indicating a line of green and red values (block 225), it is determined whether the pixel count is odd or even (block 230). Where the pixel count is odd (block 230), a red value is formed from the available YUV data using the following equation (block 245):
R=aR*Y+bR*U+cR*V+dR.
Alternatively, where the pixel count is even (block 230), a green value is formed from the available YUV data using the following equation (block 240):
G=aG*Y+bG*U+cG*V+dG.
Where, on the other hand, for a line count indicating a line of green and blue values (block 225), it is determined whether the pixel count is odd or even (block 235). Where the pixel count is odd (block 235), a green value is formed from the available YUV data using the preceding equation (block 240). Alternatively, where the pixel count is even (block 235), a blue value is formed from the available YUV data using the following equation (block 250):
B=aB*Y+bB*U+cB*V+dB.

The created RGB component value is stored in the proper pixel position resulting in the image being converted to reduced RGB color space 300 as shown in FIG. 3 (block 255). The pixel count is incremented (block 260). It is determined if the pixel count has exceeded the total number of pixels available for the image (block 265). Where the pixel count is less than the total number of pixels available from the image (block 265), the processes discussed in relation to blocks 215-265 are repeated for the incremented pixel count.

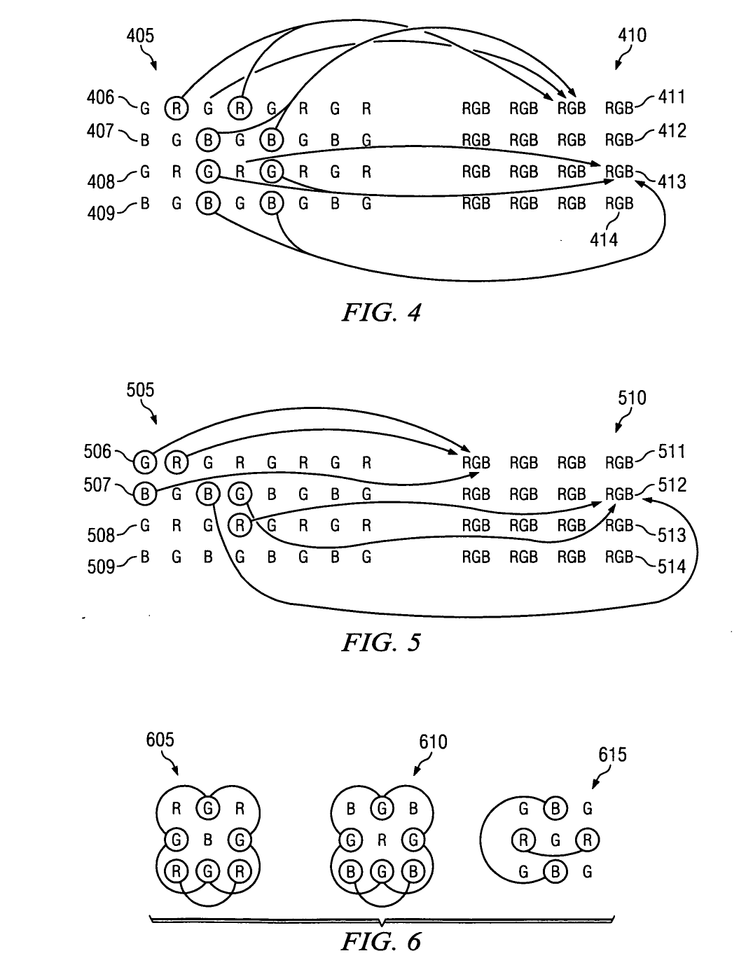

Alternatively, where the pixel count suggests that all of the pixels from the image have been processed (block 265), the pixels representing the image in the reduced color space are converted to the full color space (block 270). Thus, in this case, the image is converted from the reduced RGB color space including one component value for each pixel to a full RGB color space with all three of the red, green and blue components for each pixel. This is done in accordance with one of a variety of de-mosaicing schemes. As used herein the phrase “de-mosaicing scheme” is used in its broadest sense to mean any approach whereby missing components from a color space are formed based on other components in the color space. Thus, as an example, a de-mosaicing scheme used in relation to flow diagram 200 would provide a process whereby the full complement of red, green and blue values for every spatial or pixel location would be computed. Such an approach may be called for where the image is to be displayed using a display that requires the full complement of values. Based on the disclosure provided herein, one of ordinary skill in the art will recognize de-mosiacing schemes that may be used in relation to other color spaces and in accordance with embodiments of the present invention. Some exemplary de-mosaicing schemes are discussed below in relation to FIGS. 4-6.

Once the conversion from the reduced color space to the full color space is complete (block 270), the next image (if available) is loaded and the process is repeated. It should be noted that while the process of FIG. 2 discusses conversion from a reduced color space to the full color space, in alternative embodiments, the conversion may be from a reduced color space to a superset of the reduced color space other than the full color space.

From the preceding discussion of flow diagram 200, it will be appreciated that instead of computing R, G and B for every Y, U, V value for a given pixel location, only one color component is calculated for each spatial location. For example, for the first pixel, only the green value is computed instead of the full complement of red, green and blue values. Similarly, for the second pixel, only the red value is computed. The computational complexity when compared with that of a conventional conversion is thus directly reduced by two thirds. In such a situation, only one multiplication and one addition per pixel per component on an average to compute the image in the reduced RGB color space.

In a typically scenario, such embodiments of the present invention may provide a conversion from the YUV color space to the RGB color space using approximately seventy-five percent or less of the computational bandwidth required to perform a conventional direct YUV color space to RGB color space conversion. In one particular circumstance, the computational bandwidth of an indirect YUV color space to RGB color space conversion is reduced by forty-six percent when compared to the conventional direct YUV color space to RGB color space conversion. Based on the disclosure provided herein, one of ordinary skill in the art will recognize a variety of both hardware and software systems to which embodiments of the present invention may be applied. Further, one of ordinary skill in the art will recognize a large number of applications for one or more embodiments of the present invention. For example, the applications may include, but are not limited to, preview for image capture, video view finding, low MIPS post processing for imaging and video applications, and/or the like.

It should be noted that other reduced color spaces may also be used in relation to flow diagram 200. For example, turning to FIG. 3b, reduced RGB color space 350 may be used. Reduced color space 350 consists of a number of rows exemplified by rows 351, 355 of combined green and red components alternating with combined green and blue components; and rows 353, 357 having the opposite alternating pattern as that of rows 351, 355. Reduced color space may be used by modifying the equations used for forming the components (blocks 240-250). In particular, block 240 results in the computation of both green and red components according to the following equations:
R=aR*Y+bR*U+cR*V+dR;
G=aG*Y+bG*U+cG*V+dG.
In contrast, both blocks 245 and 250 result in the computation of both green and blue components according to the following equations
G=aG*Y+bG*U+cG*V+dG;
B=aB*Y+bB*U+cB*V+dB.
Again, based on the disclosure provided herein, one of ordinary skill in the art will recognize a variety of color spaces and/or reduced color spaces that may be utilized in accordance with the various embodiments of the present invention.

As mentioned above, several de-mosaicing schemes exist that may be used in relation to the various embodiments of the present invention. Some de-mosaicing schemes may be more suitable than others depending upon the end use of the embodiments of the present invention. Some examples that may be more desirable for embedded systems such as mobile phones include, but are not limited to: a neighbor copy interpolation technique; a two-pixel neighbor copy hybrid interpolation technique; a hybrid triangulation technique; or a modified bi-linear interpolation. Each of the aforementioned de-mosaicing schemes are linear and are thus not computationally intensive. However, it may be that in a particular circumstance a non-linear de-mosaicing scheme may be desirable.

Turning to FIG. 4, the neighbor copy interpolation technique is depicted. Such an approach provides for significant computational savings, but at the cost of reduced image quality. A reduced RGB color space 405 is interpolated to a full RGB color space 410. In particular, the interpolation proceeds by using a row 406 and a row 407 of reduced color space 405 to form a row 411 and a row 412 of full color space 410. Similarly, a row 408 and a row 409 of reduced color space 405 are used to form a row 413 and a row 414 of full color space 410.

Using this approach, for each spatial location represented by a green component, the green component is retained and the red component either to the immediate right or immediately underneath the green component are copied from the neighboring position and included with the green component at the spatial location originally occupied by only the green component. Similarly, to get the blue component, it is copied either from the immediate right of the green component or from immediately underneath the green component. For a spatial location originally only occupied by either a red component or a blue component, the existing red or blue component is retained. In addition, the green component is copied from the spatial location immediately to the right of the respective blue or red component. In addition, the missing red or blue component is copied from the right-immediate bottom diagonal pixel. As this technique merely involves copying processes, no computational cost is incurred by this type of interpolation.

Turning to FIG. 5, the two-pixel neighbor copy hybrid technique is depicted. Such an approach provides less significant computational savings when compared to the previously described approach, but provides increased image quality. A reduced RGB color space 505 is interpolated to a full RGB color space 510. In particular, the interpolation proceeds by using a row 506 and a row 507 of reduced color space 505 to form a row 511 and a row 512 of full color space 510. Similarly, a row 508 and a row 509 of reduced color space 505 are used to form a row 513 and a row 514 of full color space 510.

Using this approach, for each spatial location represented by either a red component or a blue component, the green component immediately to the left and the green component immediately to the right of the spatial location are averaged with the result being used to provide the green component for the spatial location. For a spatial location represented by a red component, the blue component is obtained by averaging the two closest blue components from the row beneath the spatial location. Similarly, for a spatial location represented by a blue component, the red component is obtained by averaging the two closest red components from the row beneath the spatial location.

For a spatial location represented by a green component on a row comprised of green components and red components, the missing red component is obtained by averaging the red component values on either side of the spatial location represented by the green component. In contrast, the blue component is obtained by copying the blue component immediately below the spatial location represented by the green component. For a spatial location represented by a green component on a row comprised of green components and blue components, the missing blue component is obtained by averaging the blue component values on either side of the spatial location represented by the green component. In contrast, the red component is obtained by copying the red component immediately below the spatial location represented by the green component.

Hybrid-triangulation techniques may also be used. Such a technique uses three neighbor pixels for interpolation. When this approach is used for a reduced color space such as that shown in FIG. 3a, for green components it is straight forward, but for red components and blue components there isn't a third pixel available on the next line that can be used for triangulation. For these components, a neighbor copy technique may be utilized.

Turning to FIG. 6, the modified-bilinear interpolation technique is depicted. In particular, three 3×3 clusters 605, 610, 615 of spatial locations are shown. In the technique, as shown by cluster 605, where the spatial location is represented by a green component on a green and red component line, the blue component is obtained by taking the blue component immediately below the spatial location. The red component is obtained by averaging the two closest red components from two lines below. Alternatively, as shown by cluster 610, where the spatial location is represented by a green component on a green and blue component line, the red component is obtained by taking the red component immediately below the spatial location. The blue component is obtained by averaging the two closest blue components from two lines below. Comparing all of the schemes discussed herein, this method yields the best quality image, and at the same time provides good computational savings. Again, it should be noted that the aforementioned de-mosaicing techniques are only some of the possible de-mosaicing techniques that may be used in relation to various embodiments of the present invention. Again, based on the disclosure provided herein, one of ordinary skill in the art will recognize other de-mosaicing schemes that may be used in accordance with embodiments of the present invention.

Some embodiments of the present invention provide systems for image acquisition and/or image display. The systems for image acquisition may include a light sensitive device that is operable to receive light representing a scene. As used herein, the phrase “light sensitive device” is used in its broadest sense to mean any device, circuit or system capable of receiving light representing an image, and converting that light into an image. Thus, a light sensitive device may be, but is not limited to a pixel array as are known in the art. Such systems may further include a conversion device that is operable to receive an image and to convert that image from one color space to another. Such a conversion device may include a processor associated with a computer readable medium that includes instructions executable by the processor to perform selected conversions. Alternatively, the conversion device may be a non-programmable hardware based conversion device, or some hybrid between the software based device and the hardware based device.

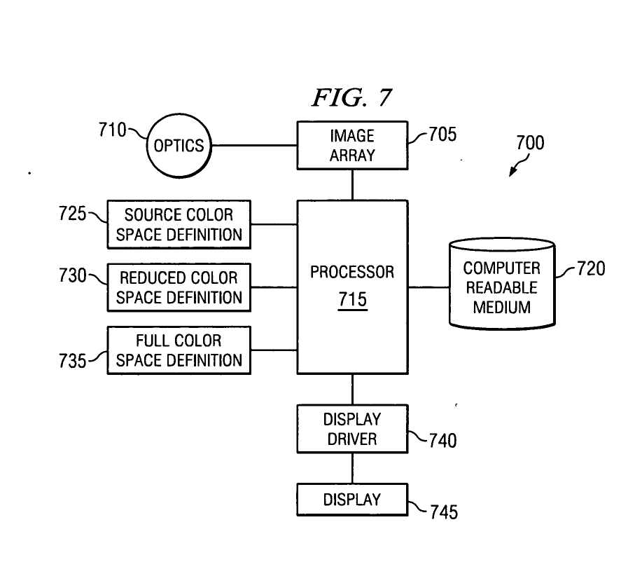

Turning to FIG. 7, an image capture and display system 700 in accordance with various embodiments of the present invention is shown. Image capture and display system 700 may be used in, but is not limited to, a mobile phone, a video camera, a digital camera, or the like. Image capture and display system 700 includes some optical device 710 that may be any device capable of receiving and transferring light reflecting off of a scene to an image array 705. Image array 705 may be any device capable of transforming the light received from optical device 710 into a representation of the scene (i.e., an image) in a particular color space. The image is available to a processor 715 that is capable of converting the image to a color space different from the color space in which the image is originally represented. As used herein, the term processor is used in its broadest sense to mean any device, circuit or system that is capable of executing instructions and performing one or more tasks disctated by such instructions. Thus, as just some examples, a processor may be, but is not limited to, a Texas Instruments™ Digital Signal Processor, or an x86 processor.

To perform the conversions, processor 715 has access to instructions defining access to and manipulation of a source color space 725, instructions defining access to and manipulation of a reduced color space 730, and instructions defining access to and manipulation of a full or some superset color space 735. Such instructions are typically software instructions are maintained on a computer readable medium 720. Such a computer readable medium 720 may be any medium that is accessible via processor based computer. Thus, for example, computer readable medium 720 may be, but is not limited to, a hard disk drive, a random access memory, a EEPROM, a CD-ROM, some combination thereof, and/or the like. Processor 715 may be electrically coupled to a display driver 740 that is capable of providing image information to a display 745.

Based on the disclosure provided herein, one of ordinary skill in the art will recognize a myriad of advantages that may be achieved through use of one of more embodiments of the present invention. For example, it will be recognized that some embodiments of the present invention exploit the eye's sensitivity to the color green to perform a computationally efficient YUV to RGB conversion. Instead of computing R, G and B for every Y, U, V value for a given pixel location, less than the full complement of components may be converted. This may result in a substantial reduction in computational bandwidth. These savings are maintained even where a conversion from the reduced color space to the full color space is performed. In some cases, a conversion from a reduced RGB color space to a full RGB color space demands only an additional 0.8 additions and 0.4 shifts per pixel per component. Over all, across four pixels and three components, where a conventional approach would require thirty-six multiplications and thirty-six additions, some embodiments of the present invention using standard bilinear interpolation demand only twelve multiplications, twenty-two additions and five shifts. This results in an overall reduction in operations from seventy-two to thirty-nine. The bilinear interpolation approach yields a Peak Signal to Noise Ratio of about 31 dB.

In conclusion, the present invention provides novel systems, methods and arrangements for exchanging data. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system for image acquisition, wherein the system comprises:
a light sensitive device, wherein the light sensitive device is operable to receive light representing a scene, and wherein the light sensitive device is operable to communicate a first image representing the scene, wherein the first image representing the scene is represented in a YUV color space;
a conversion device, wherein the conversion device is operable to:
receive the first image of the scene represented in the YUV color space; and
convert the first image of the scene represented in the YUV color space to a second image of the scene represented in a reduced RGB color space, wherein the second image of the scene represented in the reduced RGB color space includes less than a full complement of red, green and blue values for each spatial location; and
convert the second image of the scene represented in the reduced RGB color space to a third image of the scene represented in the RGB color space.

2. The system of claim 1, wherein the conversion device includes a processor and a computer readable medium accessible via the processor, and wherein the computer readable medium includes instructions executable by the processor to perform at least one of the following tasks:
receive the first image;
convert the first image to the second image; and
convert the second image to the third image.

3. The system of claim 1, wherein converting the second image of the scene represented in the reduced RGB color space to a third image of the scene represented in the RGB color space includes performing a de-mosaicing scheme selected from a group consisting of:
a neighbor copy interpolation technique;
a two-pixel neighbor copy hybrid interpolation technique;
a hybrid triangulation technique; and
a modified bi-linear interpolation.

4. The system of claim 1, wherein the reduced RGB color space includes a first row of spatial locations where each of the spatial locations are represented in alternating fashion by a single blue or green value, and wherein the reduced RGB color space includes a second row of spatial locations where each of the special locations are represented in alternating fashion by a single red or green value.

5. The system of claim 4, wherein converting the first image in the first color space to the second image in the reduced second color space includes performing a conversion for a single component for each spatial location.

6. A method for image data conversion, wherein the method comprises:
receiving a first image in a first color space;
converting the first image in the first color space to a second image in a reduced second color space; and
converting the second image in the reduced second color space to a third image in the second color space.

7. The method of claim 6, wherein the first color space is a YUV color space.

8. The method of claim 6, wherein the second color space is an RGB color space, wherein the reduced second color space is a reduced RGB color space, and wherein the reduced RGB color space has less than a full complement of red, green and blue values for each spatial location.

9. The method of claim 8, wherein the reduced RGB color space includes a first row of spatial locations where each of the spatial locations are represented in alternating fashion by a single blue or green value, and wherein the reduced RGB color space includes a second row of spatial locations where each of the special locations are represented in alternating fashion by a single red or green value.

10. The method of claim 9, wherein converting the first image in the first color space to the second image in the reduced second color space includes performing a conversion for a single component for each spatial location.

11. The method of claim 8, wherein the reduced RGB color space includes a first row of spatial locations where each of the spatial locations are represented in alternating fashion by either a blue and a green value, or a red and a green value; and wherein the reduced RGB color space includes a second row of spatial locations where each of the special locations are represented in an opposite alternating fashion than that of the first row by either a red and a green value, or a blue and a green value.

12. The method of claim 11, wherein converting the first image in the first color space to the second image in the reduced second color space includes performing a conversion for two components associated with each spatial location.

13. The method of claim 6, wherein the second color space is an RGB color space, wherein the reduced second color space is a reduced RGB color space, and wherein converting the second image in the reduced RGB color space to a third image in the RGB color space includes a de-mosaicing scheme selected from a group consisting of:
a neighbor copy interpolation technique;
a two-pixel neighbor copy hybrid interpolation technique;
a hybrid triangulation technique; and
a modified bi-linear interpolation.

14. A system for image data conversion, the system comprising:
a computer readable medium, wherein the computer readable medium includes instructions executable by a processor to:
receive a first image in a particular color space;
convert the first image in the particular color space to a second image in a reduced RGB color space; and
convert the second image in the reduced RGB color space to a third image in the RGB color space.

15. The system of claim 14, wherein the particular color space is selected from a group consisting of: a YUV color space, and an XYZ color space.

16. The system of claim 14, wherein the instructions executable by the processor to convert the second image in the reduced RGB color space to a third image in the RGB color space includes instructions executable by the processor to implement a de-mosaicing scheme selected from a group consisting of:
a neighbor copy interpolation technique;
a two-pixel neighbor copy hybrid interpolation technique;
a hybrid triangulation technique; and
a modified bi-linear interpolation.

17. The system of claim 14, wherein the reduced RGB color space includes a first row of spatial locations where each of the spatial locations are represented in alternating fashion by a single blue or green value, and wherein the reduced RGB color space includes a second row of spatial locations where each of the special locations are represented in alternating fashion by a single red or green value.

18. The system of claim 17, wherein the instructions executable by the processor to convert the first image in the particular color space to the second image in the reduced RGB color space includes instructions executable by the processor to perform a conversion of only a single component for each spatial location.

19. The system of claim 14, wherein the reduced RGB color space includes a first row of spatial locations where each of the spatial locations are represented in alternating fashion by either a blue and a green value, or a red and a green value; and wherein the reduced RGB color space includes a second row of spatial locations where each of the special locations are represented in an opposite alternating fashion than that of the first row by either a red and a green value, or a blue and a green value.

20. The system of claim 19, wherein the instructions executable by the processor to convert the first image in the particular color space to the second image in the reduced RGB color space includes instructions executable by the processor to perform a conversion for two components associated with each spatial location.
